(19) United States
(12) Patent Application Publication
(10) Pub. No.: US 2015/0268713 A1
(43) Pub. Date: Sep. 24, 2015

(54) ENERGY-AWARE BOOSTING OF PROCESSOR OPERATING POINTS FOR LIMITED DURATION WORKLOADS

(71) Applicant: Advanced Micro Devices, Inc., Sunnyvale, CA (US)

(72) Inventors: Ashish Jain, Austin, TX (US); Alexander J. Branover, Chestnut Hill, MA (US); Samuel D. Naffziger, Fort Collins, CO (US); Dongyuan Zhan, Austin, TX (US)

(73) Assignee: Advanced Micro Devices, Inc., Sunnyvale, CA (US)

(21) Appl. No.: 14/223,555

(22) Filed: Mar. 24, 2014

(51) Int. Cl. G06F 1/32

(52) U.S. Cl. CPC G06F 1/3234; G06F 1/3212

(57) ABSTRACT

The operating point of a processing unit is controlled based on the power consumption (i.e., the rate of energy consumption) associated with a workload, wherein low power consumption may indicate short-duration workloads with idle phases and high power consumption may indicate long, sustained workloads. Energy credits are accumulated while a drain rate of a battery is lower than a threshold drain rate and the energy credits are consumed while the drain rate is higher than the threshold drain rate. The operating point of the processing unit may be increased from a first operating point to a second operating point in response to the energy credits exceeding a first threshold. The operating point of the processing unit may be decreased from the second operating point to the first operating point in response to the energy credits falling below a second threshold.

### BACKGROUND

1. Field of the Disclosure

The present disclosure relates generally to processing systems and, more particularly, to power management in processing systems.

2. Description of the Related Art

Many processing systems such as laptops, tablets, or smart phones can operate in an alternating current (AC) mode, e.g. when the processing device is plugged into a wall outlet, or a direct current (DC) mode, e.g. when the processing device is unplugged and operating on an internal battery supply. Processing systems that are operating in the AC mode are conventionally optimized to enhance performance. For example, a processing unit such as a central processing unit (CPU) or graphics processing unit (GPU) in the processing system may be boosted by increasing the operating frequency or operating voltage of the CPU or GPU. Processing systems that are operating in the DC mode are conventionally optimized to conserve power. For example boosting of the CPU or GPU may be disabled to conserve power and extend battery life because boosting the processing units may drain the battery at a much higher rate than operating the processing unit at lower operating frequencies or operating voltages.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing device in accordance with some embodiments.

FIG. 2 is a plot of a battery drain rate and a plot of energy credits determined based on the battery drain rate according to some embodiments.

FIG. 3 is a plot of a battery drain rate and a plot of a skin temperature determined using one or more sensors such as sensors in the processing device shown in FIG. 1 according to some embodiments.

FIG. 4 is a flow diagram of a method for boosting one or more processing units based on energy-aware criteria according to some embodiments.

FIG. 5 is a flow diagram illustrating a method for designing and fabricating an integrated circuit device implementing at least a portion of a component of a processing system in accordance with some embodiments.

### DETAILED DESCRIPTION

The operating point of a processing unit can be boosted based upon estimates of power consumption concurrent with performance of a set of one or more tasks by the processing unit. In some cases, boosting a processing unit while it is performing the task(s) may allow the processing unit to complete the set of tasks and enter the idle mode more quickly. This race-to-idle technique may result in a net power savings, especially when the duration of the set of tasks is relatively short. Battery power in a processing system that includes the processing unit may therefore be conserved while also improving the performance of a processing system by the processing unit for the set of tasks. Embodiments of the energy-aware technique described herein allow boosting short-duration workloads with embedded idle periods, while also keeping battery life within bounds. As used herein, the term “boosting” refers to increasing the operating point of a processing unit, e.g., by increasing the operating voltage or operating frequency of the processing unit.

Some embodiments of the processing system may decide to boost a processing unit by comparing the actual battery drain rate to a threshold battery drain rate that is determined by the battery capacity and a target battery life. If the actual battery drain rate is less than the threshold battery drain rate for a predetermined time interval, indicating that the rate of energy consumption (or power consumption) is relatively low and possibly indicating that the processing unit is performing short duration tasks separated by relatively long idle periods, the processing unit can be boosted to allow the processing unit to complete its tasks more quickly. If the actual battery drain rate is larger than or equal to the threshold battery drain rate, indicating that the rate of energy consumption is relatively high and possibly indicating that the processing unit is performing long duration tasks separated by relatively short idle periods, the processing system may bypass boosting of the processing unit to conserve battery power.

Some embodiments of the processing system may base the boost decision on platform-level indicators of energy consumption in the processing system. As used herein, the term “platform-level indicator” refers to a measured parameter that indicates a physical state at one or more locations on or near the platform that supports the processing system. In some embodiments, platform-level indicators may be used to determine battery drain rates in conjunction with or as alternatives to battery status indicators. For example, one platform-level indicator is the skin temperature that is measured at one or more locations proximate to the surface of the case that encloses the processing system. Higher skin temperatures may indicate that the processing unit is performing relatively longer-duration sustained tasks separated by relatively short idle periods and so boosting of the processing unit may be bypassed when the skin temperature exceeds a threshold value.

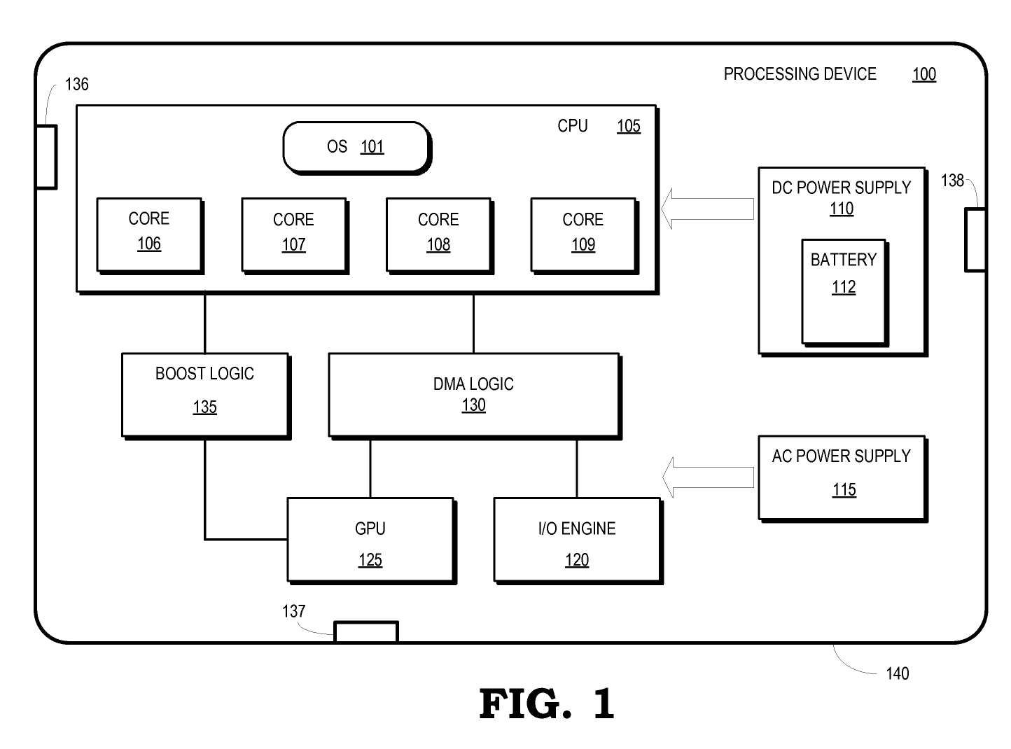

FIG. 1 is a block diagram of a processing device 100 in accordance with some embodiments. The processing system 100 includes a central processing unit (CPU) 105 for executing instructions. Some embodiments of the CPU 105 include multiple processor cores 106, 107, 108, 109 (collectively referred to hereinafter as the “processor cores 106-109”) that can independently execute instructions concurrently or in parallel. The CPU 105 shown in FIG. 1 includes four processor cores 106, 107, 108, 109 (referred to hereinafter as “the processor cores 106-109”). However, persons of ordinary skill in the art having benefit of the present disclosure should appreciate that the number of processor cores in the CPU 105 is a matter of design choice. Some embodiments of the CPU 105 may include more or fewer than the four processor cores 106-109 shown in FIG. 1. Some embodiments of the CPU 105 implement an operating system (OS) 101 to manage hardware resources of the processing device 100 and provide services for software running on the processing device 100.

The processing system 100 includes an input/output engine 120 for handling input or output operations associated with elements of the processing system such as keyboards, mice, displays, printers, external disks, and the like. A graphics processing unit (GPU) 125 is included in the processing system 100 for creating visual images intended for output to a display. Some embodiments of the GPU 125 may include multiple processor cores that are not shown in FIG. 1 in the interest of clarity.

The processing system 100 shown in FIG. 1 also includes direct memory access (DMA) logic 130 for generating addresses and initiating memory read or write cycles. The CPU 105 may initiate transfers between memory elements in the processing device 100 such as DRAM memory (not shown) or other entities connected to the DMA logic 130 including the CPU 105, the I/O engine 120 and the GPU 125. Some embodiments of the DMA logic 130 may also be used for memory-to-memory data transfer or transferring data between the processor cores 106-109. The CPU 105 can perform other operations concurrently with the data transfers being performed by the DMA logic 130 which may provide an interrupt to the CPU 105 to indicate that the transfer is complete.

Power may be supplied to components in the processing device 100 by a DC power supply 110 or an AC power supply 115. The DC power supply 110 may include a battery 112 (as shown in FIG. 1) or it may be coupled to a battery that is external to the DC power supply 110. Some embodiments of the DC power supply 110 may generate signals that indicate how fast the battery 112 (or an external battery) is being drained by supplying power to components of the processing device. These signals may be provided to entities within the processing device 100, which may use them to estimate the current level of charge in the battery 112.

The processing device 100 may preferentially operate in an AC mode so that the components of the processing device 100 receive power supplied by the AC power supply 115 when available, e.g., when the AC power supply 115 is receiving power from an external source such as a wall outlet. The battery 112 may also be charged by the AC power supply 115. The processing device 100 may transition to a DC mode when power is not available from the AC power supply 115. In the DC mode, the processing device 100 receives power from the DC power supply 110, e.g., from the internal battery 112 or an external battery (not shown) associated with the processing device 100. Techniques for selectively coupling the DC power supply 110 or the AC power supply 115 are known in the art. In the interest of clarity, logic and circuitry for selectively coupling the DC power supply 110 or the AC power supply 115 to the components in the processing device 100 are not shown in FIG. 1.

Components of the processing device 100 may be enclosed in a case 140. For example, the components of the processing device 100 may be packaged in a case 140 that is formed of plastic, metal, glass, or a combination thereof. One or more sensors 136, 137, 138 (referred to hereinafter as “the sensors 136-138”) may be positioned proximate different locations on the case 140 and may generate platform-level indicators such as temperatures. Some embodiments of the sensors 136-138 may sense the temperature near the corresponding sensor 136-138 and may be positioned on the case 140 near components that are expected to dissipate a significant amount of heat during operation. For example, the sensor 136 may be positioned on the case 140 near the CPU 105, the sensor 137 may be positioned on the case 140 near the GPU 125, and the sensor 138 may be positioned on the case 140 near the DC power supply 110. The sensors 136-138 may generate signals indicative of the temperatures measured by the sensors 136-138 and these signals may be used by other entities in the processing device 100, as discussed herein.

Processing units in the processing device 100 such as the CPU 105, the GPU 125, or the processor cores 106-109 may be operated in different power management states. Examples of power management states include an active state in which a processing unit is performing tasks or executing instructions, an idle state in which the processing unit is not performing tasks or executing instructions, or a power-gated state in which power supplied to the processing device is gated so that no current is supplied to the processing unit, thereby reducing stand-by and leakage power consumption. The processing device 100 may therefore conserve power by idling one or more processing units when there are no instructions to be executed by the processing unit(s). If the processing unit is idle for a relatively long time, power supplied to the processing unit may then be gated so that no current is supplied to the component, thereby reducing stand-by and leakage power consumption.

Performance of the processing units may also be enhanced by boosting the processing units. As used herein, the term “boosting” refers to increasing the operating point of a processing unit, e.g., by increasing the operating voltage or operating frequency of the processing unit. For example, the CPU 105 may be boosted by increasing the voltage supplied to the CPU 105 by the DC power supply 110 (when operating in the DC mode) or the AC power supply 115 (when operating in the AC mode) from a nominal voltage supplied to the processing unit while it is in the active power management state to a boost voltage that is higher than the nominal voltage. Increasing the operating voltage may also increase the operating frequency of the processing unit.

The processing system 100 shown in FIG. 1 includes boost logic 135 for determining whether one or more of the processing units should be boosted. In some embodiments, the boost logic 135 may be part of a power management controller (not shown in FIG. 1). Some embodiments of the boost logic 135 may determine that one or more of the processing units is to be boosted by increasing the operating point of the processing unit in response to an indication that a rate of energy consumption is relatively low concurrently with the processing unit performing a set of one or more tasks. The relatively low rate of energy consumption may indicate that the set of tasks includes short duration tasks separated by relatively long idle periods. Some embodiments of the processing device 100 may estimate the rate of energy consumption using a heuristic such as an energy credit that is generated by comparing an estimated drain rate of the battery 112 to a threshold drain rate. The threshold drain rate may be determined based on the total capacity of the battery 112 and a time that the processing device 100 is expected to operate in DC mode without recharging the battery 112. The battery drain rate may be determined using signals provided by the DC power supply 110, signals generated by the sensors 136-138, a combination thereof, or other signals indicative of the battery drain rate. Other heuristics, such as a skin temperature, may be used as indicators of the rate of energy consumption concurrent with tasks being performed by the processor cores 106-109 or other entities, as discussed below.

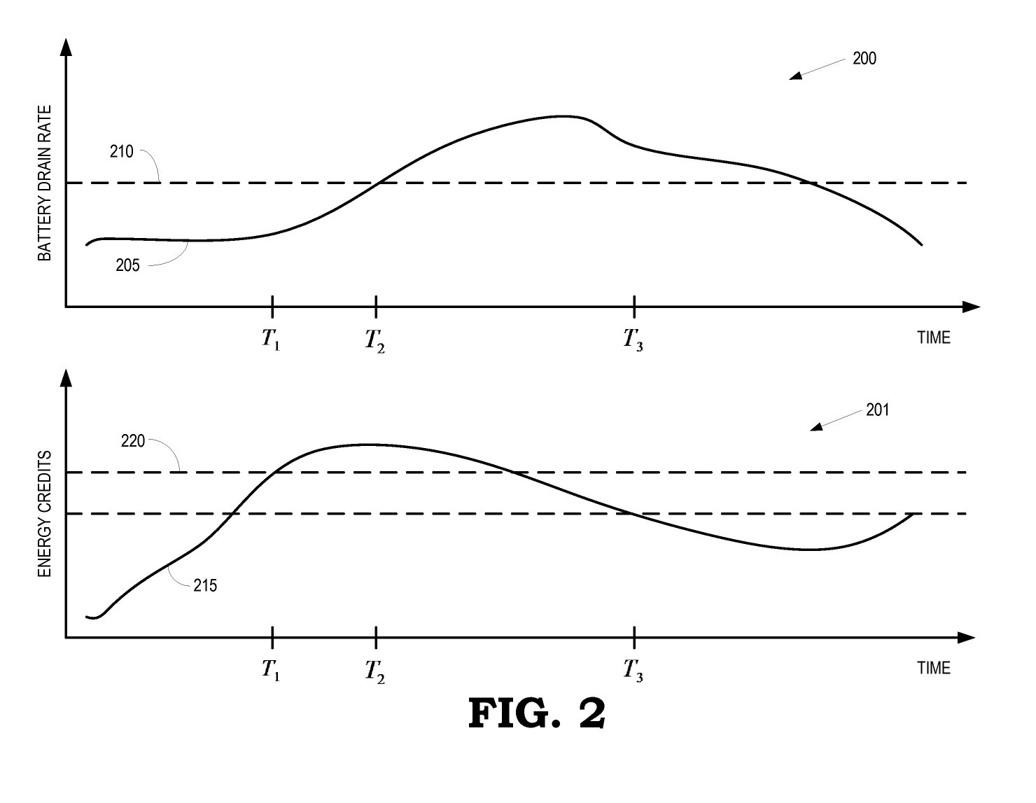

FIG. 2 shows a plot 200 of a battery drain rate and a plot 201 of energy credits determined based on the battery drain rate according to some embodiments. The horizontal axis of both plots 200, 201 indicates time increasing from left to right. The vertical axis of the plot 200 indicates the battery drain rate in arbitrary units and the vertical axis of the plot 201 indicates the energy credits in arbitrary units. The battery drain rate and the energy credits may be determined by boost logic such as the boost logic 135 shown in FIG. 1. For example, the battery drain rate may be determined using information provided by a DC power supply such as the DC power supply 110 shown in FIG. 1. The plot 200 shows the actual battery drain rate 205 determined by the boost logic and a threshold drain rate 210, which may be determined by a battery capacity and an expected DC mode duration. For example, if the battery capacity is 30 Watt-hours and the processing device is expected to operate for at least eight hours in DC mode without recharging the battery, e.g. while executing some typical or baseline use case, the reference battery drain rate may be 30/8=3.75 Watts. The plot 201 shows the energy credits 215 as they are accumulated and consumed during operation.

At times T<T₁, the actual battery drain rate 205 is less than the threshold drain rate 210, which may be an indication that one or more associated processing units are performing a set of tasks that includes one or more relatively short duration tasks separated by relatively long idle intervals. Energy credits may therefore be accumulated during this time interval, resulting in an increase in the energy credits 215. At T=T₁, the energy credit 215 reaches a threshold energy credit 220 that indicates that the processing unit(s) have been performing relatively short duration tasks for a sufficiently long time interval. The boost logic may therefore boost one or more of the processing units by increasing their operating voltage or operating frequency at T=T₁.

The boosted processing unit(s) consume energy at a higher rate and the battery drain rate 205 may therefore increase for T>T₁. Increased rate of energy consumption (or increased power consumption) may be the result of the boosted processing unit(s) performing a set of tasks that includes one or more relatively long duration tasks separated by relatively short idle intervals. Although the increased rate of energy consumption shown in FIG. 2 is the result of boosting one or more processing units, other changes may also increase the rate of energy consumption in some embodiments. For example, one or more processing units may begin to process other tasks for longer durations and shorter idle periods, which may increase the rate of energy consumption and increase the battery drain rate 205. The difference between the actual battery drain rate 205 and the threshold drain rate 210 therefore decreases until the actual battery drain rate 205 exceeds the threshold drain rate 210 at T=T₂. Consequently, the increase in the energy credit 215 slows and then begins to decrease at T>T₂ as the energy credits are consumed.

At T=T₃, the energy credit 215 reaches a threshold energy credit 225 that indicates that the processing unit(s) have been performing relatively long duration tasks that have increased the battery drain rate. The boost logic may therefore de-boost (or exit the boost) one or more of the processing units by decreasing their operating voltage or operating frequency at T=T₃. For example, if the boost logic previously boosted the operating frequency of a processing unit from a relatively low value to a relatively high value, the boost logic may de-boost the processing unit by returning its operating frequency to the relatively low value. Some embodiments may use a threshold energy credit 220 that is larger than the threshold energy credit 225 to provide a hysteresis. Some embodiments of the boost logic may also be able to de-boost one or more processing units based on other criteria such as a time limit for operating the processing unit(s) in the boosted mode.

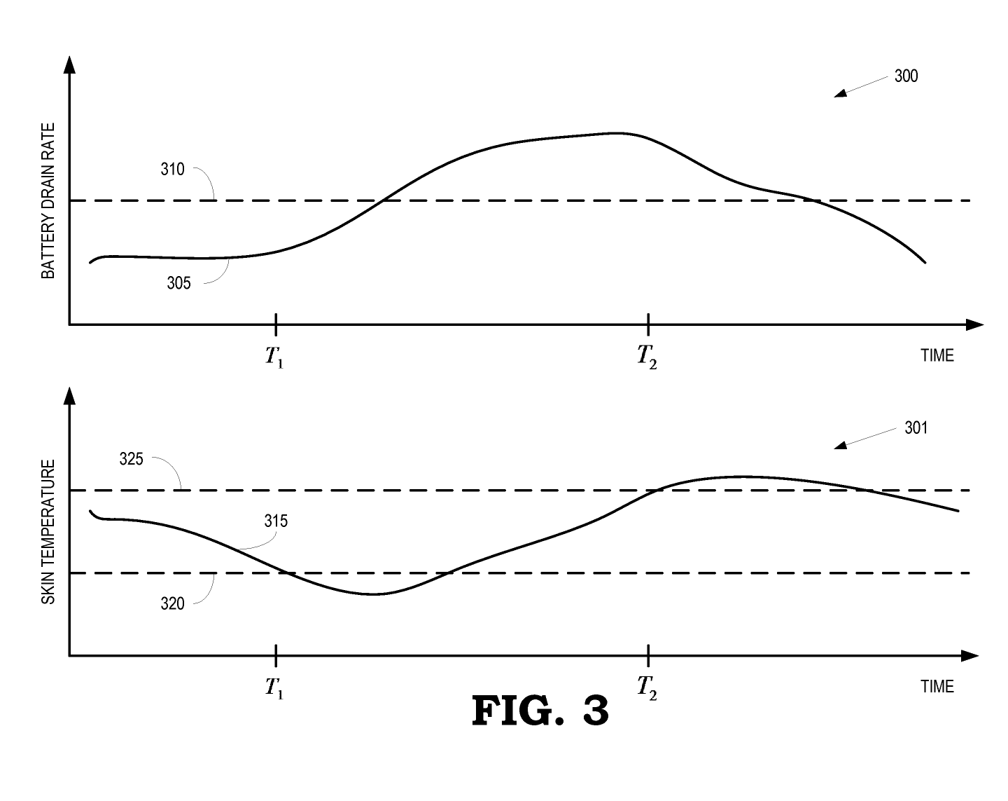

FIG. 3 shows a plot 300 of a battery drain rate and a plot 301 of a skin temperature determined using one or more sensors such as the sensors 136-138 shown in FIG. 1 according to some embodiments. The horizontal axis of both plots 300, 301 indicates time increasing from left to right. The vertical axis of the plot 300 indicates the battery drain rate in arbitrary units and the vertical axis of the plot 301 indicates the skin temperature in arbitrary units. The plot 300 shows an actual battery drain rate 305 determined by boost logic such as the boost logic 135 shown in FIG. 1. The plot 300 also shows a threshold drain rate 310, which may be determined by a battery capacity and an expected DC mode duration as discussed herein.

The plot 301 shows the skin temperature 315, which may be determined using a single sensor or a statistical combination of temperatures measured by multiple sensors. For example, the skin temperature 315 may be equal to the temperature sensed by a single sensor deployed on a case of the processing system or an average of temperatures sensed by multiple sensors deployed on the case. The skin temperature 315 varies in response to changes in the battery drain rate, which reflects changes in the platform activity and the rate of energy consumption (or power consumption). Some embodiments of the boost logic may use the skin temperature 315 as a heuristic that is indicative of the rate of energy consumption, which may also be indicative of the duration of the tasks or idle periods. Some embodiments of the boost logic may also use the measured skin temperature 315 to estimate the battery drain rate and thereby estimate the rate of energy consumption. The boost logic may then use the estimated battery drain rate to calculate a heuristic such as the energy credits shown in FIG. 2 for determining whether one or more processing units are consuming energy at a relatively high rate or a relatively low rate, e.g. while performing long or short duration tasks separated by short or long idle periods, as discussed herein.

At times T<T₁, the actual battery drain rate 305 is less than the threshold drain rate 310, which is an indication that one or more processing units may be consuming energy at a relatively low rate, e.g. while performing relatively short duration tasks separated by relatively long idle intervals. Since the processing units are operating at less than capacity, they may be dissipating a small amount of heat (e.g., relative to the cooling capacity of the system) and so the skin temperature 315 may decrease. At T=T₁, the skin temperature 315 reaches a threshold skin temperature 320 that indicates that the processing unit(s) may be consuming energy at a relatively low rate, e.g. while performing relatively short duration tasks for a sufficiently long time interval. The boost logic may therefore boost one or more of the processing units by increasing their operating voltage or operating frequency at T=T₁.

The boosted processing unit(s) consume energy at a higher rate (i.e., they consume more power) and the battery drain rate 305 may therefore increase for T>T₁. The skin temperature 315 may then begin to rise as the boosted processing unit(s) dissipates more heat. The increased rate of energy consumption may be the result of the boosted processing unit(s) performing relatively long duration tasks separated by relatively short idle intervals. Although the increased rate of energy consumption shown in FIG. 3 is the result of boosting one or more processing units, other changes may also increase the rate of energy consumption in some embodiments. For example, one or more processing units may begin to process other tasks for longer durations and shorter idle periods, which may increase the rate of energy consumption and increase the battery drain rate 305 and the skin temperature 315.

The skin temperature 315 reaches a threshold skin temperature 325 at T=T₂, which indicates that the processing unit(s) may be consuming energy at a relatively high rate, e.g. while performing relatively long duration tasks that have increased the battery drain rate and heat dissipation. The boost logic may therefore de-boost one or more of the processing units by decreasing their operating voltage or operating frequency at T=T₂. For example, if the boost logic previously boosted the operating frequency of a processing unit from a relatively low value to a relatively high value, the boost logic may de-boost the processing unit by returning its operating frequency to the relatively low value. Some embodiments may use a threshold skin temperature 325 that is larger than the threshold skin temperature 320 to provide a hysteresis. Some embodiments of the boost logic may also be able to de-boost one or more processing units based on other criteria such as a time limit for operating the processing unit(s) in the boosted mode.

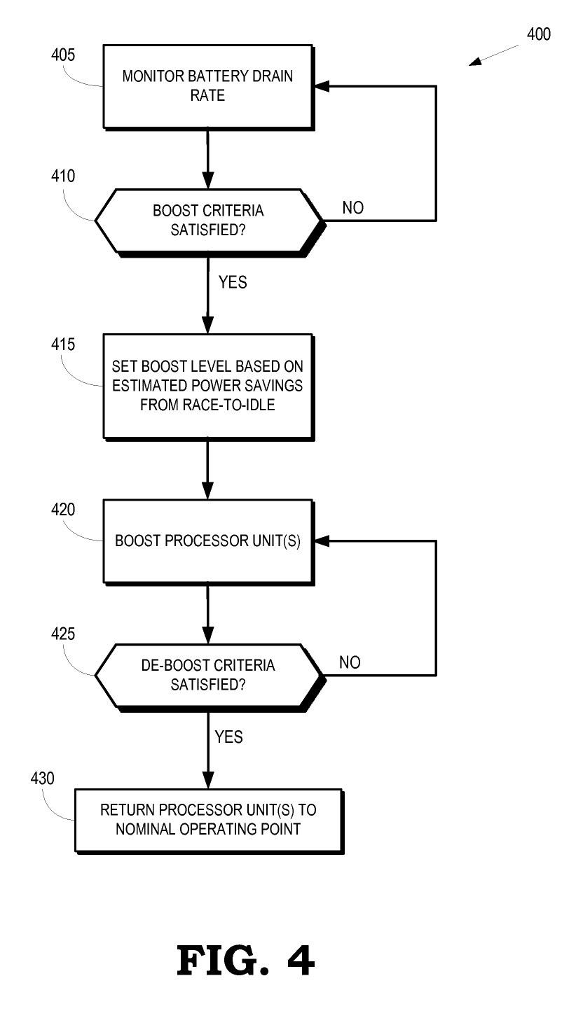

FIG. 4 is a flow diagram of a method 400 for boosting one or more processing units based on energy-aware criteria according to some embodiments. Some embodiments of the method 400 may be implemented for use while tasks are being processed by the processing unit(s) in a DC mode. However, embodiments of the method may also be used to bound or constrain the rate of energy consumption while tasks are being processed by the processing unit(s) in an AC mode. The method 400 may be implemented in boost logic such as the boost logic 135 shown in FIG. 1. At block 405, the boost logic monitors a drain rate of a battery used to supply power to the processing unit(s) while operating in a DC mode. The battery drain rate may be monitored directly, e.g., using information generated are provided by a DC power supply such as the DC power supply 110 shown in FIG. 1, or indirectly, e.g., using platform-level information generated or provided by sensors such as the sensors 136-138 shown in FIG. 1. At decision block 410, the boost logic determines whether a boost criteria has been satisfied. For example, the boost logic may determine whether accumulated energy credits have exceeded a threshold (as shown in FIG. 2) or whether a skin temperature has fallen below a threshold (as shown in FIG. 3). If not, the boost logic continues to monitor the battery drain rate at block 405.

In response to the boost criteria being satisfied (at decision block 410), the boost logic may set a boost level for one or more processing units at block 415. Some embodiments of the boost logic may set the boost level by determining an operating frequency or an operating voltage for the processing units based on an estimated power savings that would result from the race-to-idle created by boosting the processing units. The power savings may be estimated by determining how many platform components of the processing system may be able to enter an idle state by completing a process earlier as a result of the increase in the operating frequency or operating voltage of the boosted processing units. For example, the race-to-idle may allow a memory or a display associated with the process to be released sooner, thereby reducing power consumption. A larger boost (e.g., a larger increase in the operating frequency or operating voltage) may be selected if it results in a power savings that offsets the increased power consumption of the boosted processing units. The boost logic may generate signals that cause the processing unit(s) to be boosted at block 420.

At decision block 425, the boost logic determines whether a boost exit criteria has been satisfied. For example, the boost logic may determine whether accumulated energy credits have fallen below a threshold (as shown in FIG. 2) or whether a skin temperature has risen above a threshold (as shown in FIG. 3). If not, the processing unit(s) may remain in the boosted state. Once the boost exit criteria has been satisfied at decision block 425, the boost logic may generate signals that cause the processing unit(s) to return to their nominal operating point. For example, the processing unit(s) may be returned to the operating point that was used prior to boosting the processing unit(s) at block 420.

In some embodiments, the apparatus and techniques described above are implemented in a system comprising one or more integrated circuit (IC) devices (also referred to as integrated circuit packages or microchips), such as the processing device described above with reference to FIGS. 1-4. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

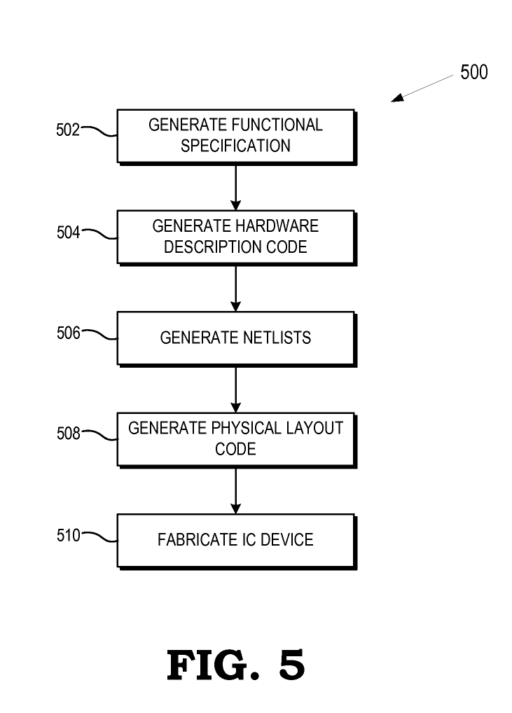

FIG. 5 is a flow diagram illustrating an example method 500 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 502 a functional specification for the IC device is generated. The functional specification (often referred to as a micro architecture specification (MAS)) may be represented by any of a variety of programming languages or modeling languages, including C, C++, SystemC, Simulink, or MATLAB.

At block 504, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 506 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 508, one or more EDA tools use the netlists produced at block 506 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 510, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
modifying an operating point of a processing unit of a processing system based on a rate of energy consumption concurrent with performance of a set of one or more tasks by the processing unit.

2. The method of claim 1, wherein modifying the operating point of the processing unit comprises increasing at least one of an operating voltage supplied to the processing unit or an operating frequency of the processing unit.

3. The method of claim 1, wherein modifying the operating point of the processing unit comprises increasing the operating point of the processing unit in response to an indication that a drain rate of a battery that supplies the battery power to the processing unit is below a threshold drain rate.

4. The method of claim 3, further comprising:
determining the drain rate of the battery using information generated by a direct current (DC) power supply to indicate the drain rate of the battery.

5. The method of claim 3, further comprising:
determining the drain rate of the battery using at least one platform-level indicator that indicates the drain rate of the battery.

6. The method of claim 5, wherein determining the drain rate of the battery comprises determining the drain rate of the battery using at least one skin temperature measured proximate to at least one location on a case that contains the processing unit.

7. The method of claim 3, further comprising:
accumulating energy credits while the drain rate is lower than the threshold drain rate; and
consuming energy credits while the drain rate is higher than the threshold drain rate.

8. The method of claim 7, wherein increasing the operating point of the processing unit comprises increasing the operating point of the processing unit from a first operating point to a second operating point in response to the energy credits exceeding a first threshold.

9. The method of claim 8, wherein modifying the operating point comprises decreasing the operating point of the processing unit from the second operating point to the first operating point in response to the energy credits falling below a second threshold.

10. A non-transitory computer readable storage medium embodying a set of executable instructions, the set of executable instructions to manipulate a processing system to:
modify an operating point of a processing unit of a processing system based on a rate of energy consumption concurrent with performance of a set of one or more tasks by the processing unit.

11. The non-transitory computer readable storage medium set forth in claim 10, wherein the set of executable instructions manipulate the processing system to:
accumulate energy credits while a battery drain rate is lower than a threshold drain rate;
consume energy credits while the battery drain rate is higher than the threshold drain rate;
increase the operating point of the processing unit from a first operating point to a second operating point in response to the energy credits exceeding a first threshold; and
decrease the operating point of the processing unit from the second operating point to the first operating point in response to the energy credits falling below a second threshold.

12. An apparatus comprising:
a processing unit; and
boost logic to modify an operating point of the processing unit based on a rate of energy consumption concurrent with performance of a set of one or more tasks by the processing unit.

13. The apparatus of claim 12, wherein the boost logic is to modify the operating point of the processing unit by increasing at least one of an operating voltage supplied to the processing unit or an operating frequency of the processing unit.

14. The apparatus of claim 12, further comprising:
a battery to supply power to the processing unit, and wherein the boost logic is to modify the operating point by increasing the operating point of the processing unit in response to an indication that a drain rate of the battery is below a threshold drain rate.

15. The apparatus of claim 14, further comprising:
a direct current (DC) power supply, and wherein the boost logic is to determine the drain rate of the battery using information generated by the DC power supply to indicate the drain rate of the battery.

16. The apparatus of claim 14, wherein the boost logic is to determine the drain rate of the battery using at least one platform-level indicator that indicates the drain rate of the battery.

17. The apparatus of claim 14, further comprising:
a case to contain the processing unit; and
at least one sensor to measure at least one skin temperature proximate at least one location on the case, wherein the boost logic is to determine the drain rate of the battery using said at least one skin temperature.

18. The apparatus of claim 14, wherein the boost logic is to accumulate energy credits while the drain rate is lower than the threshold drain rate and consume energy credits while the drain rate is higher than the threshold drain rate.

19. The apparatus of claim 18, wherein the boost logic is to modify the operating point by increasing the operating point of the processing unit from a first operating point to a second operating point in response to the energy credits exceeding a first threshold.

20. The apparatus of claim 19, wherein the boost logic is to modify the operating point by decreasing the operating point of the processing unit from the second operating point to the first operating point in response to the energy credits falling below a second threshold.
